(19) United States
(12) Patent Application Publication
(10) Pub. No.: US 2025/0333183 A1
(43) Pub. Date: Oct. 30, 2025

(54) SYSTEM AND METHOD FOR MANAGING AN ENERGY SOURCE IN A HYBRID ELECTRIC PROPULSION ARCHITECTURE

(71) Applicants: Airbus (S.A.S.), Blagnac (FR); Airbus Operations (S.A.S.), Toulouse (FR)

(72) Inventors: Lars Kornstaedt, Blagnac (FR); Mohamed Khaled Kahalerras, Toulouse (FR); Gilian Antonio, Toulouse (FR); Israe Drissi El Bouzaidi, Toulouse (FR); Lancelot Perrotte, Toulouse (FR); Olivier Basset, Toulouse (FR)

(73) Assignees: Airbus (S.A.S.), Blagnac (FR); Airbus Operations (S.A.S.), Toulouse (FR)

(21) Appl. No.: 19/192,594

(22) Filed: Apr. 29, 2025

(30) Foreign Application Priority Data
Apr. 30, 2024 (FR) FR2404554

(51) Int. Cl. B64D 31/18; B64D 27/33

(52) U.S. Cl. CPC B64D 31/18; B64D 27/33

(57) ABSTRACT

An aircraft with an energy management system for an electrical energy source in a hybrid electric propulsion architecture with at least one heat engine, an avionics system and components conveying parameters of the aircraft. An energy management module stores functions available for a given mission of the aircraft that are likely to be used by the engine and allowing assistance from the source, as well as the necessary associated charge required for the execution thereof. A controller is provided for authorizing their execution and ensuring the execution of the safety functions, the controller being linked to the components, to the electrical energy source and to an engine activation module in order to send it the authorized functions according to the control that has been completed.

### TECHNICAL FIELD

The disclosure herein relates to a system and a method for managing the electrical energy supplied by an electrical energy source, such as a battery, in an aircraft with a hybrid electric propulsion architecture.

### BACKGROUND

The disclosure herein applies to hybrid-energy mechanical power supply architectures, namely, originating both from the use of fuel and batteries in order to electrically assist the heat engine. The batteries thus notably allow the engine to be provided with surplus energy for operations requiring high power, such as starting, take-off or landing, engine acceleration, climbing/descending altitude, and stopping the engine, and to avoid oversizing it for short operational phases or emergency situations. Such architectures lead to a reduction in fuel consumption and the carbon footprint.

The aim of the disclosure herein is to optimize the use of these batteries and to avoid completely discharging them before the end of a mission or to such an extent that safety requirements requiring power from the batteries can no longer be met.

To this end, the disclosure herein relates to an aircraft comprising an energy management system for an electrical energy source in a hybrid electric propulsion architecture comprising at least one heat engine using fuel combustion and the electrical energy source, the aircraft comprising an avionics system and components conveying parameters of the aircraft, wherein it comprises: an energy management EM module that stores functions available for a given mission of the aircraft that are likely to be used by the engine and allowing assistance from the source, as well as the necessary associated charge required for the execution thereof; a controller MC for controlling the status of the components required for executing each of these available functions that have been transmitted by the management module it is connected to, as well as the amount of required energy likely to be delivered by the source to authorize their execution and ensure the execution of the safety functions, the controller being linked to the components, to the electrical energy source and to an engine activation module in order to send it the authorized functions according to the completed control.

The energy management system thus optimizes the use of electrical assistance while guaranteeing the execution of safety functions until the end of the mission.

### SUMMARY

The disclosure herein provides at least one of the following optional features, taken in isolation or in combination.

The energy management EM module stores an energy management plan to ensure the execution of the safety functions and provides, throughout a mission, a set of functions available per given mission segment and an amount of energy required for each function for the segment.

The energy management EM module stores degraded energy management plans providing updates to the management plan in the event of anomalies.

The disclosure herein also relates to a method for managing the energy of an electrical energy source in an aircraft having one of the optional features described above, taken in isolation or in combination, wherein it comprises the following steps:
upon receiving specific aircraft parameter(s), transmitting (step B) a set of available functions, stored in the energy management module, associated with these parameters to the controller and the charge required for executing these functions and the controller checking the proper operation of the aircraft components required for executing the received available functions and the amount of electrical energy from the source that must be sufficient to ensure the execution thereof and that of the safety functions;
if the available functions can operate correctly and the amount of energy likely to be delivered by the source is sufficient (VFd), the controller authorizes (step C) the execution of the functions and transmits the authorized functions to the module for activating the engine;
when the engine activates an authorized function (ActivFa), throughout the execution of the function, the controller checks (step D) that the authorized function does not consume abnormally and, if this is the case, the controller notifies the engine that the authorization for the relevant function is withdrawn (step F).

When the consumption while executing an authorized function abnormally exceeds the expected consumption by a certain determined amount, in step F, the controller sends a signal to the engine computer EC notifying it that the authorization for the current authorized function is withdrawn after a certain number of seconds to allow time for the engine computer EC to configure itself to the non-electrical assistance mode.

In a first step A, functions available for an aircraft mission are stored in the energy management module together with the associated necessary charge required for the execution thereof.

When the engine computer EC receives a request to activate a function, it checks (VFa) that the function is authorized to use electrical assistance and execute the relevant function.

The energy management module continuously checks that the energy consumption matches the mission energy plan (step BB) so as to ensure a minimum charge level for executing the safety functions and, in the event of an anomaly Vcons (Y), the energy plan is updated in a step CC and is replaced by a degraded energy plan.

The energy management module continuously checks that the energy consumption matches the degraded energy plan (step DD) so as to ensure a minimum charge level for executing the safety functions and, in the event of an anomaly Vconsdgr (Y), the energy plan is updated in a step CC and is replaced by another degraded energy plan.

### BRIEF DESCRIPTION OF THE DRAWINGS

Further aims, features and advantages will become apparent from the following description of the disclosure herein, which is provided solely by way of a non-limiting example, with reference to the appended drawings, in which:

FIG. 1 is a simplified top view of an aircraft provided with a system according to the disclosure herein;

FIG. 2 is a schematic view of the energy management system according to the disclosure herein;

FIG. 3 is a synopsis of an example of the various mission segments identified for a given mission of a given aircraft;

FIG. 4 is a diagram of the energy management method according to the disclosure herein.

### DETAILED DESCRIPTION

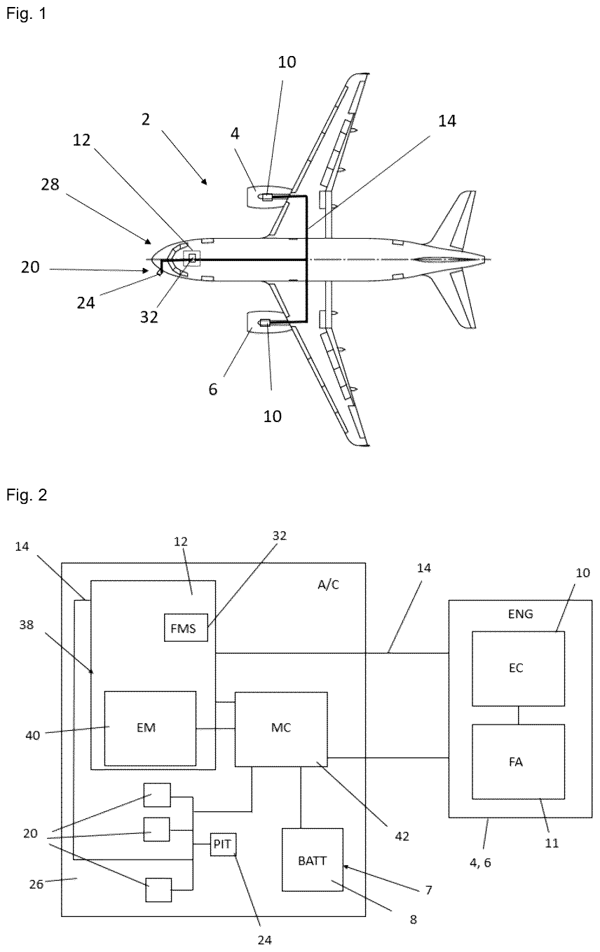

As shown in FIG. 1, the disclosure herein relates to an aircraft 2 provided with a hybrid electric propulsion architecture, namely, as indicated above, whose heat engine can be electrically assisted. In such an architecture, the electrical energy also can be used for the requirements of the aircraft, such as, for example, those of the aircraft equipment and more specifically, for example, the management of the cabin air, called the ECS (Environmental Control System). The aircraft comprises at least two heat engines Eng 4, 6, as well as an electrical energy source 7 and in this case, more specifically, a battery BATT 8, shown in FIG. 2. The heat engine 4, 6 can be, for example, a turbojet engine and, more specifically, can be a turbofan engine, by way of an example, or even a propfan engine. Each engine 4, 6 comprises an engine computer EC 10 and an activation module FA 11. The module FA 11 can be integrated into the computer EC 10 or can be independent, as shown in FIG. 2. The engine computers 10 are connected to an avionics system 12, also called avionics core, by a communication network 14. The communication network 14 also links the avionics system 12 to components 20 of the aircraft that transmit aircraft parameters thereto. The components 20 include all the elements, equipment and other parts required for executing an available function. In FIG. 1, one of the components, a Pitot probe PIT 24 for measuring the aircraft speed parameter, is shown as an example of a component 20 of the aircraft 2.

FIG. 2 schematically shows one side of the aircraft A/C as a whole without the engines 4, 6 and the other side with the engines Eng 4, 6. All the systems shown in the aircraft A/C can be located in different possible places on the aircraft: for this reason, they are not shown in FIG. 1. The avionics system 12 is conventionally mainly located in the cockpit 28 and/or close to it, as is schematically shown in FIG. 1, but this could be different, at least for part of the system. The electrical energy source 7 is a generic term for designating any type of battery, supercapacitor or other energy storage source, as well as any combination of sources of the same or different types. The source 7 is, in the illustrated embodiment and as indicated above, a battery 8 and, for example, a Lithium type battery and, more specifically, Lithium-ion or, according to another example, an LIP (lithium-iron-phosphate) battery. Throughout the remainder of the description, reference will be made to the battery charge, but if the energy source is of a type other than a battery, the charge corresponds to the amount of remaining electrical energy likely to be delivered by the source. In a schematic and simplified manner, the aircraft 2 comprises the aircraft part A/C 26, which controls the aircraft during flight, connected to an engine part Eng 4, 6, which provides propulsion. The aircraft part A/C 26 comprises numerous modules of a known type, such as the flight management module 32 (or Flight Management System (FMS)). The avionics system 12 of the cockpit 28 is connected to components 20 by the network 14, as well as to the engines 4, 6 ENG. The source 7, in this case the battery BATT 8, is connected to specific components 20.

The aircraft 2 comprises a management system 38 for the battery 8. The management system 38 for the battery 8 comprises an energy management EM module 40 connected to a controller MC 42, which itself is connected to the engines Eng 4, 6. The modules 40 and 42 can be in the form of independent computers or can be integrated into existing computers. In the illustrated embodiment, the energy management module 40 is a computer forming part of the avionics system 12. The module 42 is integrated into an independent computer that interfaces with the engine. However, any other embodiment can be contemplated. The avionics system 12 is connected to the controller MC 42. The controller MC 42 is linked to the battery 8 and to the communication network 14, enabling it to connect to a set of specific aircraft components 20.

The energy management EM module 40 stores available functions for a given mission of the aircraft 2 likely to be used by the engine 4, 6 and to allow assistance from the battery 8; the associated charge required for the execution thereof is also stored, as will be seen hereafter. The controller MC 42 checks the status of the components 20 required for executing each of these available functions transmitted by the module 40, as well as the charge level of the battery 8 to authorize the execution thereof.

The energy management method described hereafter is more specifically based on an energy management plan for a given mission of the relevant aircraft in order to make optimal use of electrical assistance and to guarantee safety functions, as will be seen hereafter. The energy plan anticipates battery charging at appropriate times. Throughout the mission, the energy management module 40 checks that the energy consumption is in line with the plan: the module 40 is aware of the charge level of the battery 8 via the controller 42. The mission corresponds to all the operations of an aircraft for a given flight from a passenger embarkation point to a disembarkation point. Indeed, during the taxiing phases before take-off and after landing, and even during operations such as engine shutdown, the aircraft can use electrical assistance to perform operations. The mission therefore includes operations preceding and following the actual flight of the aircraft. The energy management EM module 40 stores the electrical energy management plan. Before a flight, the energy management plan is established for the relevant mission and a crew member enters the energy management plan corresponding to the relevant flight into the module 40 when the aircraft is on the ground using a human-machine interface provided for this purpose. The flight plan also can be downloaded from the ground.

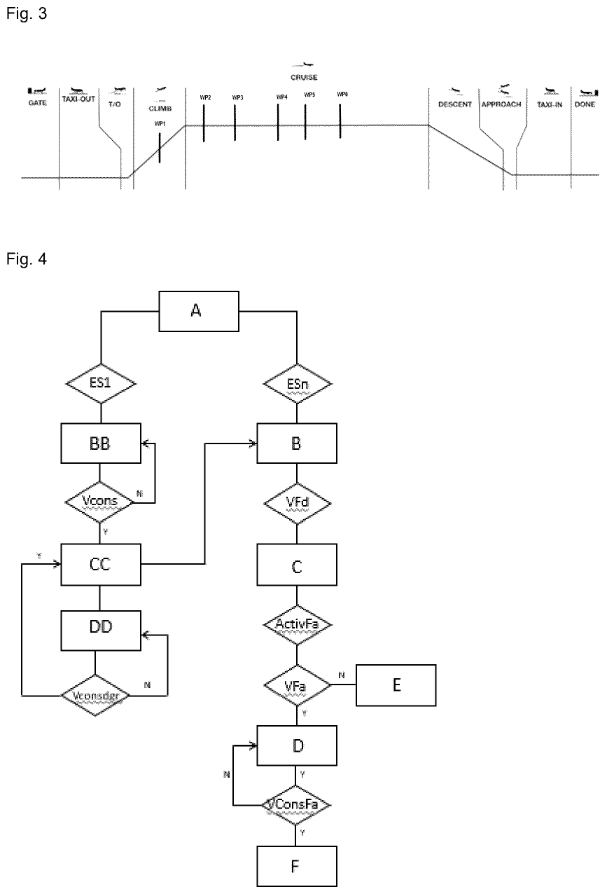

In order to optimize the use of energy for a given mission, the various operational phases of an aircraft do not need the same requirements and for a given phase, depending, for example, on limitations from air traffic control or even weather changes, the requirements change along the journey. The disclosure herein therefore involves, as shown in FIG. 3, segmenting the entire mission of an aircraft: a set of necessary functions is provided for each segment that can use electrical assistance powered by the battery, and a required amount of electrical energy originating from the battery 8 to perform these functions is computed. The same function can be found in several segments (or even all of them), but not necessarily with the same operating conditions. Thus, an acceleration function can be essential for take-off but not necessarily for cruising.

The mission of an aircraft 2 is divided into a set of segments that can be established in multiple ways. The number of segments depends on the length of the mission. One possible way of dividing the mission into segments is described hereafter and is illustrated in FIG. 3. An airplane is flown along a flight plan comprising a series of waypoints. The segments in the illustrated embodiment are defined according to the flight phases (including the ground phases) from the embarkation point to the disembarkation point and also, for example, according to the waypoints. Thus, as shown in FIG. 3, a segment can correspond to a flight phase: the parking segment at the embarkation point, called “GATE”, the taxiing segment before take-off, called “TAXI OUT”, the take-off segment, called “T/O”, the climbing segment to a first cruising altitude, called “CLIMB”, the cruising segment, called “CRUISE”, the descent segment, called “DESCENT”, the landing segment, called “APPROACH”, the taxiing segment after landing, called “TAXI IN”, the parking segment at the disembarkation point, called “DONE”. Some of these segments can be subdivided into several segments established, for example, using waypoints (WP1 to WP6 in FIG. 3). The climb segment thus could be divided into several segments: the climb segment “CLIMB”, for example, is made up of two segments, as shown in FIG. 3. The cruise phase is the longest operational phase of an aircraft. It is therefore subdivided into several segments. The energy management plan specifies the functions for each segment that can use electrical assistance for the relevant segment and the corresponding charge required to complete them for the given segment.

Some of the charge of the battery 8 is allocated for safety functions and must not be used for other functions under any circumstances. A safety function is, for example, the engine restart assistance function, or even the power supply for computers if electrical generation is lost. Thus, a minimum charge level is computed so that all the safety functions likely to be performed by electrical assistance can be available and fully achievable. An additional charging delta can be provided to determine this minimum level. This delta can be the sum of a delta specific to each function or an overall delta for all the functions. The minimum charge level corresponds to a threshold that the battery charge level must not drop below. The module 40 continuously checks, as will be seen hereafter, the energy consumption in relation to the energy plan designed to ensure this minimum battery charge level: to this end, it regularly ensures that the energy consumption does not exceed the consumption anticipated in the energy plan by a certain amount. The module 40 continuously carries out this check to interrupt electrical assistance in the event of an anomaly causing the level to be exceeded. The module 40 can also optionally continuously check that the charge level is much higher than the minimum level, which is an additional check to guarantee the execution of safety functions until the end of the mission.

The energy management module 40 can also store degraded management plans, namely, alternative energy management plans that the system uses in the event of an anomaly. There can be various kinds of anomaly, for example, a component failure, an electrical failure, a change of route with such an impact on energy consumption that it could mean, as will be described hereafter, that it is no longer possible to provide a minimum charge at the energy source to guarantee the execution of the safety functions. These anomalies are taken into account in order to deploy new management plans, called degraded management plans, to guarantee this minimum charge. These anomalies are either of a known type or are discovered and recorded during flights. When a new degraded plan is proposed to the pilot, there are always less optimized alternative plans, also called degraded plans, which will also be displayed in case the pilot does not confirm the first proposed degraded plan. It is also possible to provide degraded management plans to be chosen by the company and/or the pilot. Examples of available functions are engine start assistance (starter actuation) or engine acceleration assistance when the aircraft wishes to accelerate on the ground or in flight. The engine shutdown assistance function is another function, as are the idle and engine cooling functions.

According to an optional mode of the disclosure herein, the energy management EM module 40 can be accessed by the pilot. Indeed, in the event of a change due to an anomaly, the pilot has access to the module 40 in order to modify the planned energy management plan. In this alternative, several options are possible. One of them involves proposing degraded energy management plans to the pilot, as seen above. A degraded mode can replace the main mode when conditions are met at the request of the pilot or automatically, as will be seen hereafter.

The following description describes the energy management method illustrated in FIG. 4 using the system described above. The energy management method comprises a step A of establishing the energy plan for a mission of a specific aircraft, as well as degraded plans in case of anomalies. The one or more plans in question are stored in the energy management EM module 40. Other embodiments are possible in which the plans can be partly automatically developed.

When the aircraft mission begins, the available functions are determined at a given frequency and, in the following example, each time a given segment is entered. The avionics system 12 transmits parameters PARAM1 signifying entry into a flight segment to the energy management EM module 40. Each time a given segment ESn is entered, the energy management EM module 40 sends, in a second step B (called available functions transmission step) the controller MC 42 all the available functions Fd for the relevant segment, as well as the associated charge required for each of these functions for this same segment according to the mission energy plan or according to a degraded plan following an update, as will be seen hereafter. The controller MC checks that all the available functions required for the relevant segment can operate correctly. Thus, the controller MC 42 checks whether all the components 20 required for executing each of these functions are operating correctly. It also checks whether the battery charge 8 is sufficient for the charge allocated to each of these functions. If this is the case (VFd), the controller MC 42 sends, in a fourth step C (called authorized function transmission step Fa), the engine ENG activation module FA 11 the one or more authorized functions and the corresponding necessary charge. When the engine computer 10 needs to activate (ActivFa) the engine in order to perform a function ƒ1, it checks (VFa) that the function ƒ1 is an authorized function and, if this is the case (Y), in a step D, it activates the function ƒ1 to use the electrical assistance. In the illustrated embodiment, with the computer connected to the activation module FA, but independent, either the module FA transmits the authorized functions upon receipt, or the computer polls the activation module when necessary in order to obtain them. If the function ƒ1 is not an authorized function (N), the engine operates in a step E without using electrical assistance. If the function ƒ1 is activated, throughout the execution of the authorized activated function ƒ1, the module 42 controls its consumption VConsFa. In the event that the consumption when executing the function ƒ1 in the relevant segment exceeds the expected consumption by a certain predetermined amount or in the event of an anomaly (Y), in a step F, the controller MC 42 sends a signal to the engine computer ECU notifying it that the authorization for the current function ƒ2 is withdrawn after a certain number of seconds to allow the engine computer ECU time to configure itself to non-electrical assistance mode.

As soon as it enters the first segment ES1, the energy management module 40, in a step BB, continuously checks that the energy consumption is in line with the mission energy plan and that there is no anomaly in relation to the established energy plan. The module 40 can also check that the battery charge level does not reach a threshold it must not drop below in order to ensure the safety functions. Indeed, it is essential that a certain minimum charge must be maintained in the battery to enable safety functions to operate. For each available function, an associated amount of energy is provided that is equal to or greater than that required for its operation to ensure that the battery has this minimum charge in case the safety functions are used.

In the event of an anomaly Vcons (Y), the energy plan must be updated. In a step CC, the energy management module sends one or more degraded plans to the module FMS 32, which plans are proposed to the pilot, who may or may not validate them. If they validate one, the new degraded energy plan is taken as a reference and is updated in the management module 40. If they do not validate any, a degraded emergency plan is automatically confirmed after a certain number of seconds. According to another possible embodiment, in the step CC, the degraded plan is automatically executed and the pilot is informed as such. The pilot can modify the current degraded plan at any time.

If a degraded plan is confirmed, the energy management module updates the current energy plan and redefines the available functions corresponding to the new degraded plan, as indicated above in step B (when the energy plan is updated). The method then proceeds as described above from step B on the basis of the updated energy plan, namely, the degraded energy plan. Furthermore, in the same way as for the initial energy plan, the energy management module 40, in a step DD, continuously checks that the energy consumption is in accordance with the updated degraded energy plan and that there is no anomaly in relation to the updated energy plan; optionally, the module checks that the battery charge level is well above the minimum level defined above. If this is the case Vconsdgr (Y), the method again resumes the sequence from step CC in order to determine a new degraded energy plan.

Thus, the system and the method according to the disclosure herein, by providing optimized degraded plans in advance for using the battery in terms of electrical assistance, allows the fuel allocated to a mission for a given amount of battery charge to be computed and used as accurately as possible.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising an energy management system for an electrical energy source in a hybrid electric propulsion architecture comprising at least one heat engine using fuel combustion and the electrical energy source, the aircraft comprising an avionics system and components conveying parameters of the aircraft, comprising:
an energy management module that stores functions available for a given mission of the aircraft that are likely to be used by the engine and allowing assistance from the source, as well as a necessary associated charge required for execution thereof; and
a controller for controlling a status of the components required for executing each of the available functions that have been transmitted by the management module it is connected to, as well as an amount of required energy that can be delivered by the source to authorize their execution and ensure execution of the safety functions, the controller being linked to the components, to the electrical energy source and to an engine activation module in order to send it the authorized functions according to a completed control.

2. The aircraft according to claim 1, wherein the energy management module stores an energy management plan to ensure the execution of the safety functions and provides, throughout a mission, a set of functions available per given mission segment and an amount of energy required for each function for the segment.

3. The aircraft according to claim 2, wherein the energy management module stores degraded energy management plans providing updates to the management plan in an event of anomalies.

4. A method for managing energy of an electrical energy source in the aircraft according to claim 1, comprising:
upon receiving one or more specific aircraft parameters, transmitting a set of available functions, stored in the energy management module, associated with the parameters to the controller and the charge required for executing the functions and the controller checking proper operation of the aircraft components required for executing the received available functions and the amount of electrical energy from the source that must be sufficient to ensure the execution thereof and that of the safety functions;
if the available functions can operate correctly and the amount of energy likely to be delivered by the source is sufficient, the controller authorizes the execution of the functions and transmits the authorized functions to the module for activating the engine;
when the engine activates an authorized function, throughout the execution of the function, the controller checks that the authorized function does not consume abnormally and, if so, the controller notifies the engine that the authorization for the function is withdrawn.

5. The method according to claim 4, wherein when consumption while executing an authorized function abnormally exceeds an expected consumption by a certain determined amount, the controller sends a signal to an engine computer notifying it that the authorization for the authorized function is withdrawn after a certain number of seconds to allow time for the engine computer to configure itself to a non-electrical assistance mode.

6. The method according to claim 4, wherein functions available for an aircraft mission are stored in the energy management module together with the associated necessary charge required for the execution thereof.

7. The method according to claim 4, wherein when an engine computer receives a request to activate a function, it checks that the function is authorized to use electrical assistance and execute the function.

8. The method according to claim 2, wherein the energy management module continuously checks that energy consumption matches an mission energy plan to ensure a minimum charge level for executing the safety functions and, in an event of an anomaly, the energy plan is updated and is replaced by a degraded energy plan.

9. The method according to claim 8, wherein the energy management module continuously checks that the energy consumption matches the degraded energy plan to ensure a minimum charge level for executing the safety functions and, in an event of an anomaly, the energy plan is updated and is replaced by another degraded energy plan.
